(19) United States
(12) Patent Application Publication
(10) Pub. No.: US 2007/0283524 A1
(43) Pub. Date: Dec. 13, 2007

(54) Sliding door closer mechanism

(75) Inventor: Graham Gordon, Brampton (CA)

Correspondence Address: SAND & SEBOLT, AEGIS TOWER, SUITE 1100, 4940 MUNSON STREET, NW, CANTON, OH, 44718-3615, US

(73) Assignee: TOTE'L INDUSTRIES CORP., Brampton (CA)

(21) Appl. No.: 11/450,037

(22) Filed: Jun. 8, 2006

(51) Int. Cl. E05F 1/10

(52) U.S. Cl. 16/78

(57) ABSTRACT

An automatic door closer for a sliding door. The closer mechanism includes a base mounted onto one of a sliding door and a door frame, a spring-biased block and tackle mechanism mounted within the base and a cable that is connected to the other of the sliding door and door frame. The closer includes a selectively activated locking mechanism that engages the cable and prevents its movement into or out of the base, thereby preventing the closer from automatically shutting the door.

### BACKGROUND OF THE INVENTION

1. Technical Field

This invention generally relates to sliding doors. More particularly, the invention relates to a closer mechanism for sliding glass doors and sliding screens. Specifically, the invention relates to an automatic closer mechanism for a sliding door that comprises a spring-tensioned block and tackle mechanism and includes a lock for selectively disabling the closer to allow for manual operation of the door.

2. Background Information

The frames for sliding-type glass doors with sliding screens are made from many different materials such as wood, aluminum and plastic. Each manufacturer makes different systems with different size doors and clearances between the sliding glass panels and the screen panels. The screen panels are very light and move easily, but the glass doors are much heavier and require more effort to move. When sliding doors are opened they remain that way until the user physically closes them again. Unless the user pays attention, the door may not close all the way, thus allowing insects to fly into the house, heated or cooled air to escape from the building and provides a space through which younger children may exit the building or can use to slide a screen, for instance, out of the way to exit the building.

Several patents have addressed this need for a way to bias a sliding door into a closed position. U.S. Pat. No. 4,126,912 to Johnson; U.S. Pat. No. 4,357,732 to Hickman; U.S. Pat. No. 4,891,011 to Yung and U.S. Pat. No. 4,884,369 to Tatham include gravity-activated mechanisms for closing a sliding door. Other patents, such as U.S. Pat. No. 4,003,102 to Hawks et al having included pneumatic cylinders for achieving the same end. Still others, such as U.S. Pat. No. 4,004,372 have included coils springs and dampeners for achieving this end. U.S. Pat. No. 5,131,188 to Hutchison et al; U.S. Pat. No. 4,819,925 to Kaftan and U.S. Pat. No. 4,301,623 to Demukai have included block and tackle mechanisms for closing sliding doors.

All of these patents have disclosed closing mechanisms for automatically shutting sliding doors. One of the problems with these devices is, however, that as soon as the user removes their hand, the closing mechanisms automatically engage and the door begins to slide shut. There are instances where this is undesirable, such as when the user wishes to carry something through the door entryway, for instance, hamburgers recently cooked on the barbeque. It is difficult to keep the door from closing automatically with one hand, step over the door threshold and hold the cooked food in the other hand.

There is therefore a need in the prior art for an automatic closer mechanism that automatically closes the door when that is so desired, but that can be disabled to prevent the door from automatically sliding shut when the door is released.

### SUMMARY OF THE INVENTION

The device of the present invention is an automatic door closer for sliding doors. Lighter weight doors, such as screen doors, would have a smaller, lighter closer mechanism attached thereto and heavier sliding doors such as glass doors would have a larger, heavier duty closer mechanism attached thereto.

The automatic door closer comprises a base which is mounted to the exterior of one of a sliding door and a door frame. The base includes a block and tackle mechanism where the block slides along the base between two end caps. A cable extends outwardly from the base and is attached to the other of the sliding door and door frame. The base is mounted on a surface by one of screws, rivets, two-sided tape or any other suitable fastening mechanism. One or more tension springs are connected at one end to the sliding block and to the other end to one of the end caps so as to bias the door into a closed position. When the door is opened, a length of cable is drawn out of the closer mechanism. As soon as the door is released, the springs return to their rest position and as they do so, they cause the block to slide along the base and draw the length of cable back into the closer mechanism. The closer mechanism further includes a mechanism for locking the cable so that it cannot be drawn out of or into the base. A first embodiment of the locking mechanism comprises a cam lock that applies pressure to the cable and prevents it from moving until the cam lock is released. A second embodiment of the locking mechanism comprises a slide lock that includes a housing and a spring-biased plunger that is selectively depressed into the housing. When the plunger is in a depressed position the cable can slide freely through the slide lock, and when the plunger is in a released position the cable cannot slide through the slide lock. The slide lock is therefore positionable on the cable to stop the movement of the door at the slide lock's position.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a front view of a sliding door with the closer of the present invention attached thereto in a first orientation and showing the door in an open position;

FIG. 2 is an enlarged front view of the closer mounted to the top of the sliding door;

FIG. 3 is an exploded perspective view of the closer in accordance with the present invention;

FIG. 3A is an exploded perspective view of the closer which utilizes a double spring system;

FIG. 4 is an enlarged partial front view of the closer;

FIG. 5 is a partial top view of the closer through line 5-5 of FIG. 4;

FIG. 6 is a partial front view of the closer mechanism with the base removed for clarity and illustrating the placement of the components when the door is in a closed position;

FIG. 7 is a partial front view of the closer mechanism with the base removed for clarity and illustrating the placement of the components when the door is in an open position;

FIG. 8 is a partial cross-section front view of the end cap and base showing the cam lock in an open position;

FIG. 8a is a perspective view of the end cap showing the cam lock in an open position;

FIG. 9 is a partial cross-sectional front view of the end cap and base showing the cam lock in a closed position;

FIG. 9a is a perspective view of the end cap showing the cam lock in a closed position;

FIG. 10 is a front view of a sliding door with the closer mounted in a second position, and showing the door in a partially open position;

FIG. 11 is an enlarged front view of the highlighted portion of FIG. 10;

FIG. 12 is a front view of the sliding door with the closer mechanism disposed in the second position and showing the door in the closed position;

FIG. 13 is a front view of a second embodiment of the closer mechanism in accordance with the present invention;

FIG. 14 is an enlarged cross-sectional front view of the circled area of FIG. 13 and showing the sliding cord lock;

FIG. 15 is a perspective view of the frame fastener

FIG. 15a is a top view of the frame fastener of FIG. 15;

FIG. 16 is a perspective view of the fastener cover;

FIG. 16a is a top view of the fastener cover;

FIG. 17 is a partial perspective view of the closer mechanism and the initial installation of the frame fastener member; and

FIG. 18 is a partial perspective view of the closure mechanism, frame fastener and fastener cover in a fully installed state.

### DETAILED DESCRIPTION OF THE INVENTION

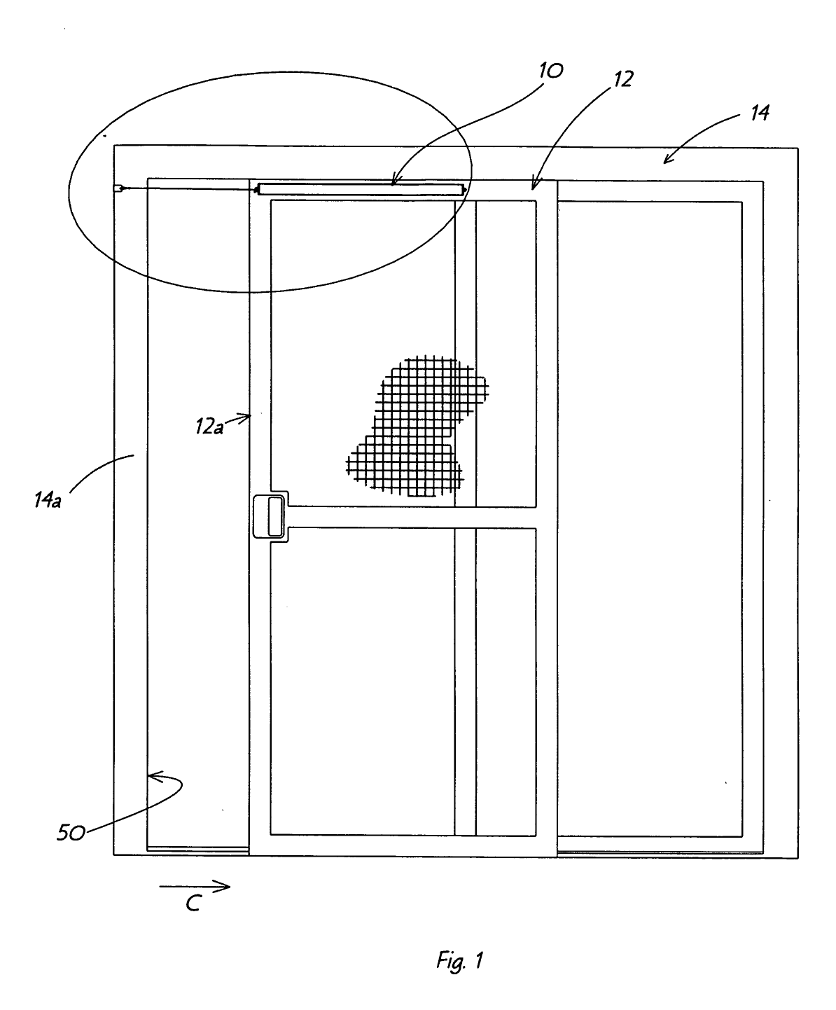

Referring to FIG. 1 there is shown an automatic closer mechanism in accordance with the present invention and generally indicated at 10. Closer mechanism 10 is mounted on a sliding door 12 and is connected at a first end to the door frame 14. Closer mechanism 10 allows door 12 to be opened and then when released by the user, slides automatically back into a closed position.

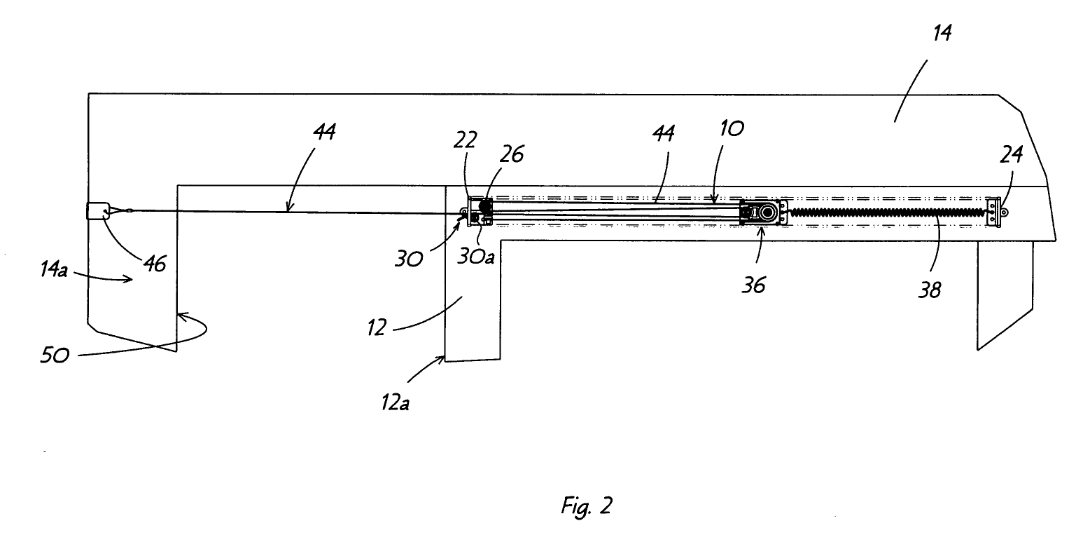

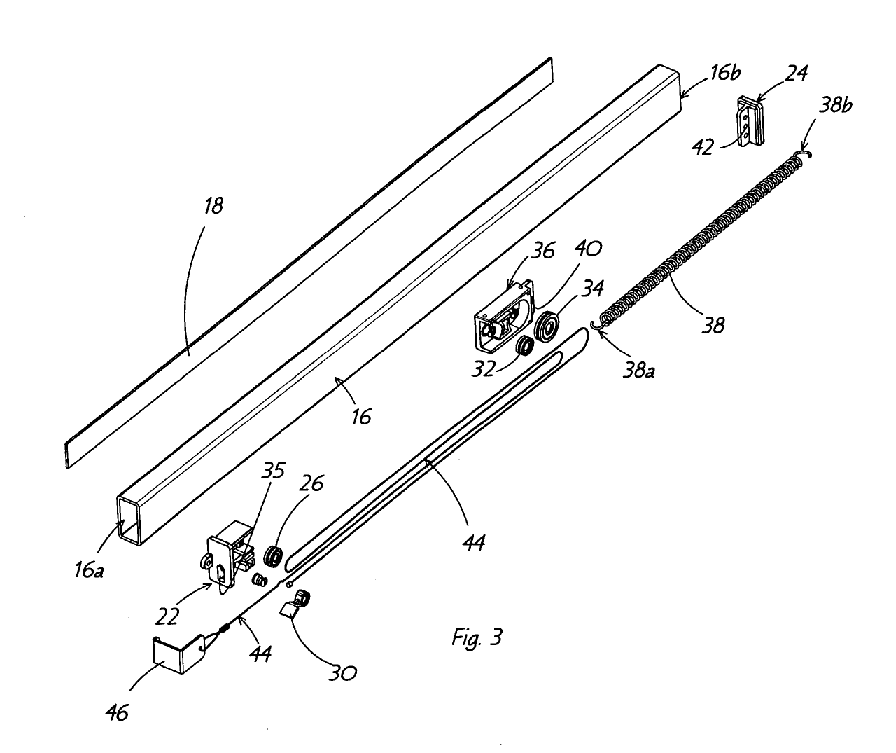

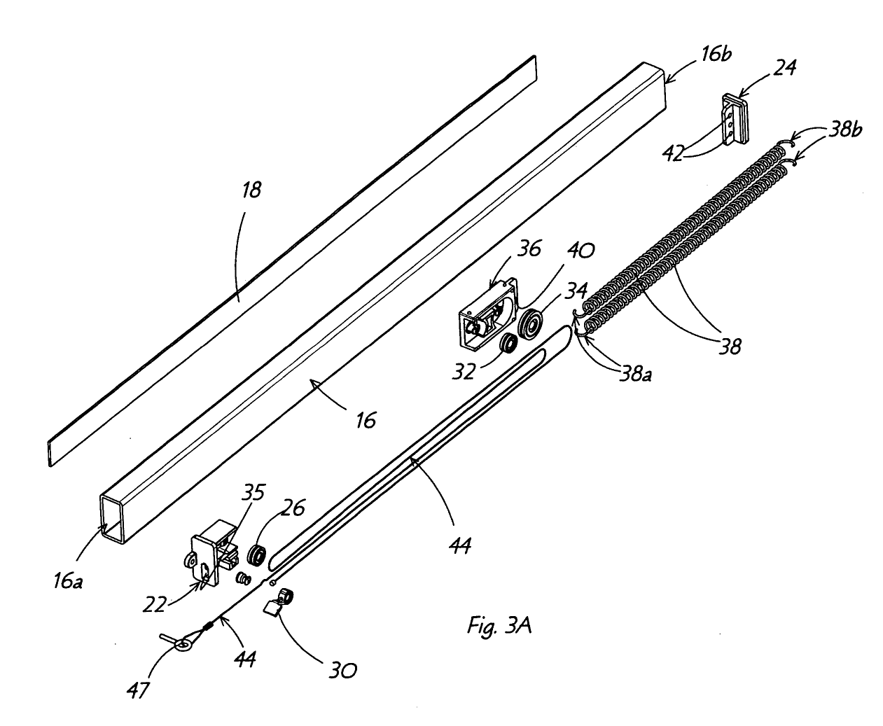

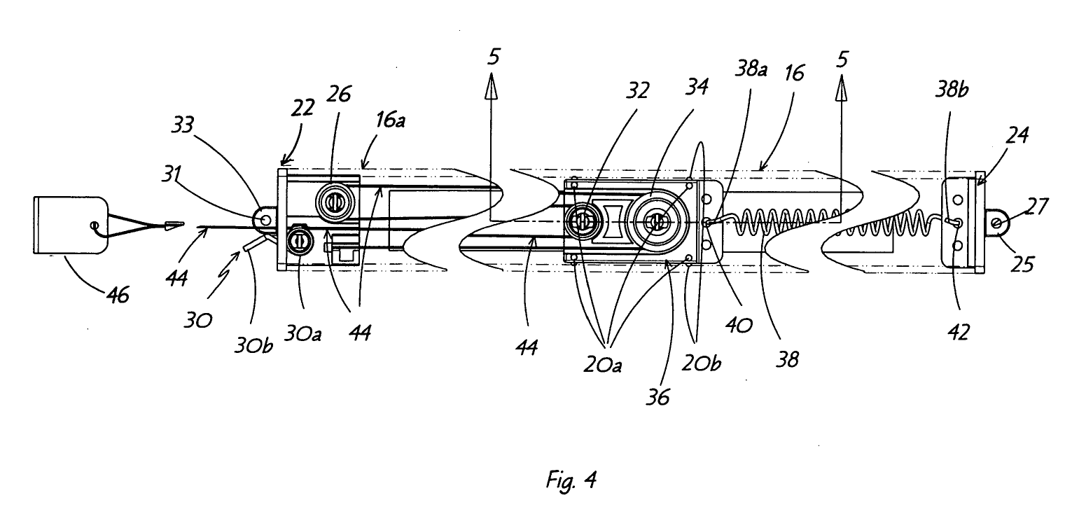

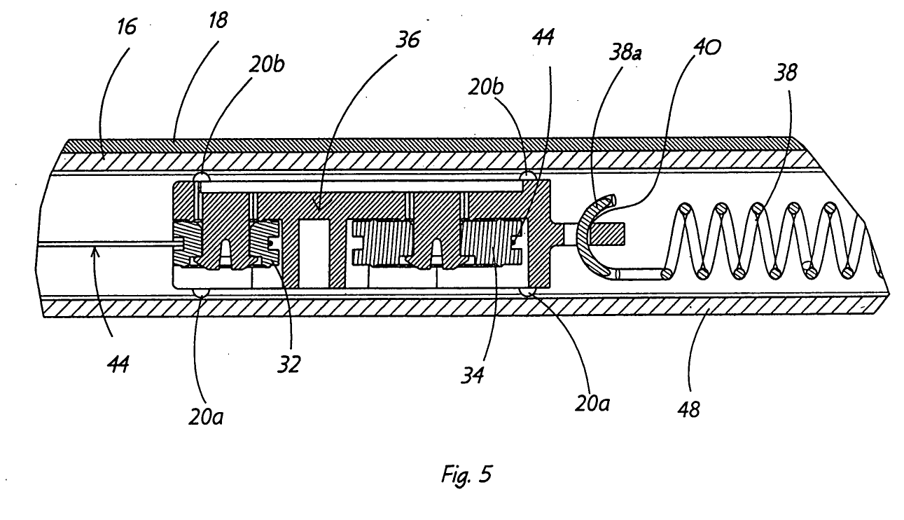

Referring to FIGS. 2-5, closer mechanism 10 includes a base 16 which is mounted onto door 12 by way of a suitable connector such as two-sided tape 18. Alternative mounting methods for base 16 can include screws, rivets or hook and pile fasteners. Base 16 is an elongated member that is substantially rectangular in cross-section and includes an internal bore 20 therethrough. Injection molded end caps 22 and 24 are mounted one at each end of base 16, with end cap 22 being disposed proximate a first end 16a of base 16 and end cap 24 being disposed proximate the second end 16b thereof. A fastener (not shown) may be inserted through a hole 31 in a tab 33 on end cap 22 to secure end cap 22 to door 12. A second fastener (not shown) may be inserted through a hole 27 in a tab 25 on end cap 24 to secure that end cap to door 12. A slidable block 36 is disposed within the bore 20 in base 16 and intermediate end caps 22 and 24. A first pulley 26 is provided on end cap 22 and a second set of pulleys, 32, 34 is provided upon block 36. Cable 44 is attached to either one of end cap 22 and block 36 at a first end. Cable 44 is then threaded around pulleys 26, 32, 34; through an aperture 35 in end cap 22 and attached at a second end by a fastener to door frame 14. A suitable fastener is an L-shaped frame member 46 (FIG. 3) that is received around a portion of frame 14 or a pin 47 (FIG. 3A) which is screwed into frame 14 or is inserted into a pre-drilled hole therein. End cap 24 is also provided with an aperture 42 therein. One or more coil springs 38 (FIGS. 3 and 3A) extend between block 36 and end cap 24, with a first end of each spring 38a being hooked through an aperture 40 in block 36 and a second end 38b of each spring 38 being hooked through aperture 42 in end cap 24. Springs 38 bias door 12 into a closed position.

Base 16 and end caps 22, 24 preferably are manufactured from an extruded vinyl plastic. Spring 38 keeps the end caps 22 and 24 drawn toward each other and thereby holds closer mechanism 10 together. Block 36 reciprocates between end caps 22 and 24 in response to the opening and closing of door 12. Closer mechanism 10 consequently comprises a block and tackle type of arrangement mounted within base 16.

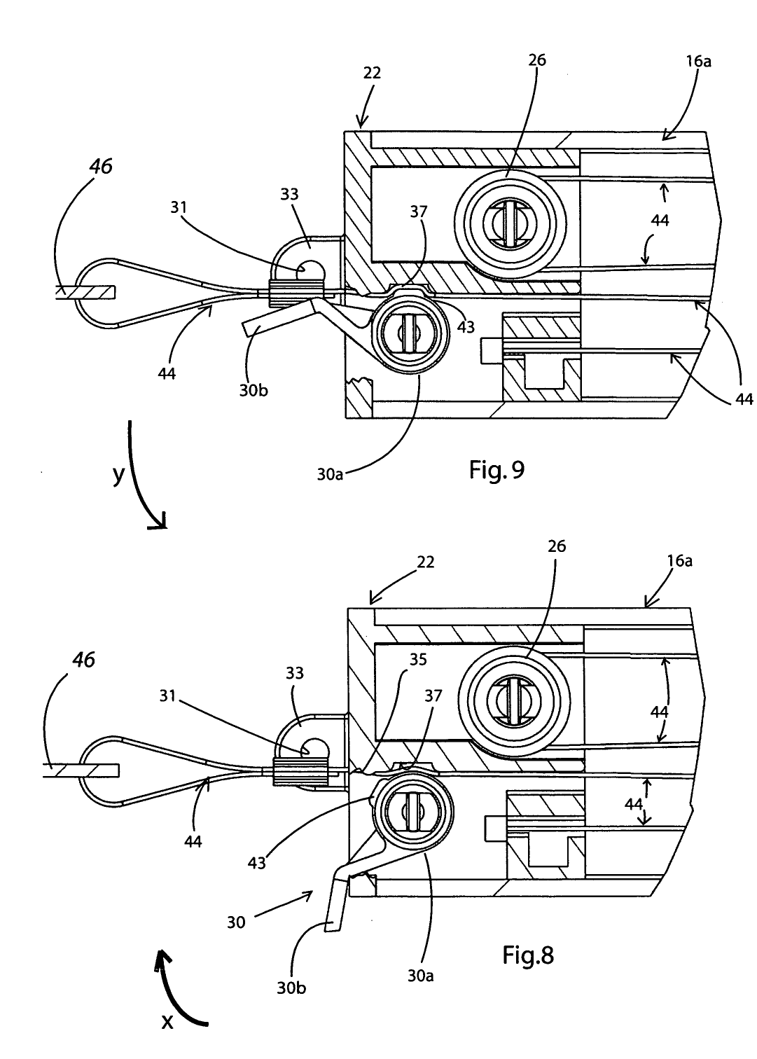

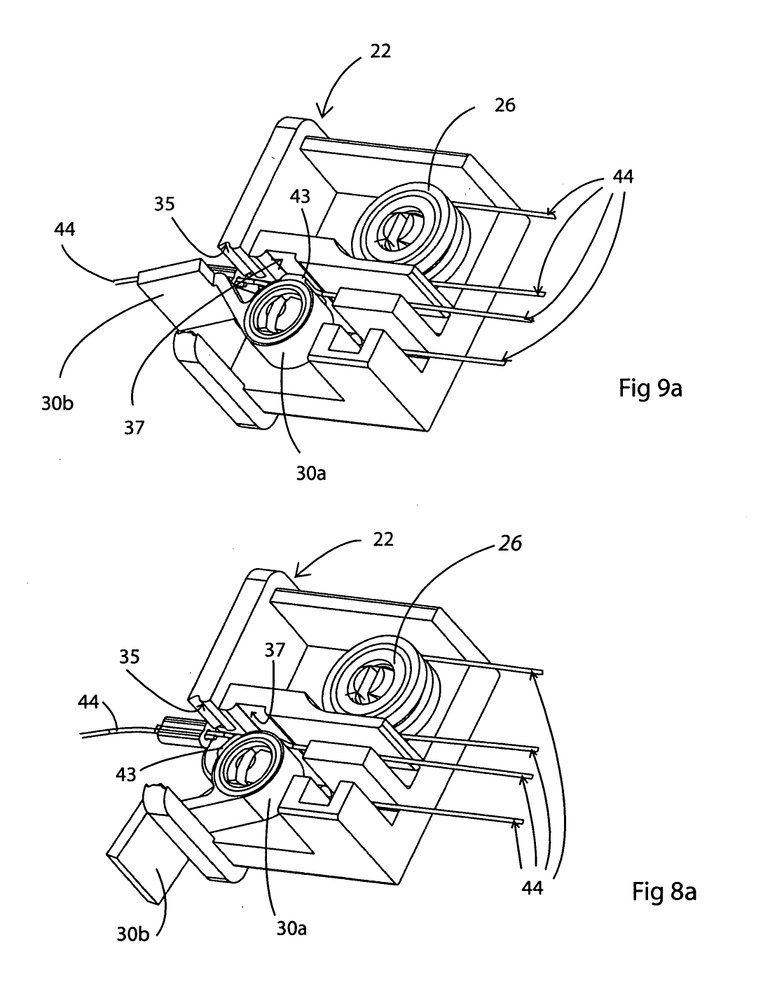

In accordance with a specific feature of the present invention, closer 10 is provided with a locking mechanism 30 that may be enabled to prevent door 12 from closing automatically. Locking mechanism 30 preferably comprises a cam lock 30 which is mounted on end cap 22 proximate pulley 26 (FIGS. 3, 4, 8 &9). Cam lock 30 includes a first part 30a mounted on end cap 22 proximate pulley 26 and a second part 30b which projects outwardly from first part 30a and through aperture 35 in end cap 22. Second part 30b is flanged so that it may be more easily engaged by the user. Cable 44 is threaded through aperture 35 and is disposed between second part 30b and a part of the interior surface 37 of the end cap 22 surrounding aperture 35. When second part 30b of cam lock 30 is in an unengaged position (FIG. 8), the cable 44 can be freely moved through aperture 34. When second part 30b of cam lock is engaged (FIG. 9), cable 44 is wedged between interior surface 37 and second part 30b. Consequently, cable 44 cannot be drawn through aperture 35.

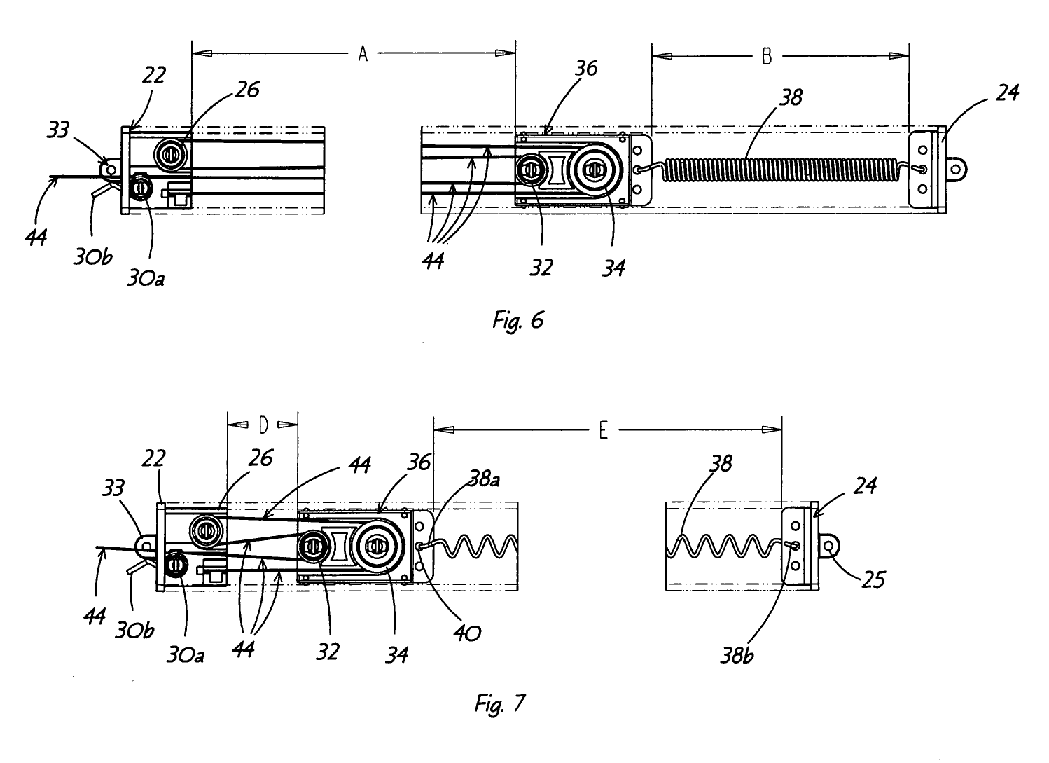

Referring to FIGS. 1, 4, 6&7, the automatic closer mechanism 10 is used in the following manner. FIG. 6 illustrates the resting position of closer 10 and FIG. 7 illustrates the tensioned position of closer 10. Cam lock 30 is shown in both FIGS. 6 & 7 in a locked position. When closer 10 is in the rest position (FIG. 6), block 36 is spaced a first distance “A” from end cap 22 and spring has a length “B”. When door 12 is drawn open in the direction of arrow “C” (FIG. 1), block 36 slides along tracks 20a, 20b toward end cap 22. This shortens the distance between end cap 22 and block 36 to the length “D” (FIG. 7), expands spring 38 to a length “E” and allows a length of cable 44 to be drawn outwardly from between the end caps 22 and 24 and through aperture 35 in block 36. The movement of door 12 in the direction of arrow “C” also opens up an entryway 50 through which the user can step. Distance “D” is smaller than distance “A” and length “E” is longer than the length “B”.

When the user is on the opposite side of door 12 and releases the cam lock 30, the tension in the expanded spring 38 causes it to revert back to its original length “B” and as it does so, spring 38 causes block 36 to slide along tracks 20a, 20b in the opposite direction, i.e., toward end cap 24. The movement of block 36 along base 16 draws cable 44 inwardly through aperture 35 with the drawn in length of cable being taken up by the expanding distance between the pulleys 26, 32 and 34. As cable 44 is drawn in through end cap 22, the leading edge 12a of door 12 is drawn toward the vertical upright 14a of frame 14, i.e., door 12 is pulled into a closed position.

Referring to FIGS. 8-9a, there are, however, instances where it is desirable to keep door 12 in an open position, for example, when the user wants to carry some object through the entryway and does not want the door sliding shut before this can be accomplished. If this is the case, then cam lock 30 may be engaged when the door is opened to the desired extent. In order to engage cam lock 30, the user merely pushes upwardly on second part 30b of cam lock 30 as indicated by arrow “X”. This upward movement causes first part 30a of cam lock 30 to rotate in end cap 22, thereby causing a cam 43 to slide into a recess 37 and thereby wedging cable 44 between cam 43 and the interior surface of the recessed area (FIG. 9). This wedging action substantially prevents cable 44 from being drawn outwardly through aperture 35 or inwardly into aperture 35. Because cable 44 cannot be moved in either direction, the door remains in exactly that opened position. If the user decides that door 12 is not opened to the desired extent, then they move second part 30b of cam lock 30 downwardly in the direction of arrow “Y” (FIG. 9). This movement causes cam 30 to rotate in end cap 22, sliding cam 43 out of recess 37 and thereby releasing cable 44. When the door 12 has been moved to the newly desired position, the user pushes second part 30b of cam lock 30 upwardly in the direction of arrow “X”, causing cam 43 to slide back into recess 37 and thereby wedging a section of cable 44 between cam 43 and the interior wall of recess 37. When the user wishes to allow door 12 to close completely, cam lock 30 is disengaged by rotating second part 30b downwardly in the direction of arrow “Y”, causing cam 43 to slide out of recess 37 and out of engagement with cable 44. Cable 44 can then be once again drawn inwardly through aperture 35 as block 36 slides on base 16. This movement continues until the leading edge 12a of door 12 engages vertical upright 14a of frame 14 (FIG. 1).

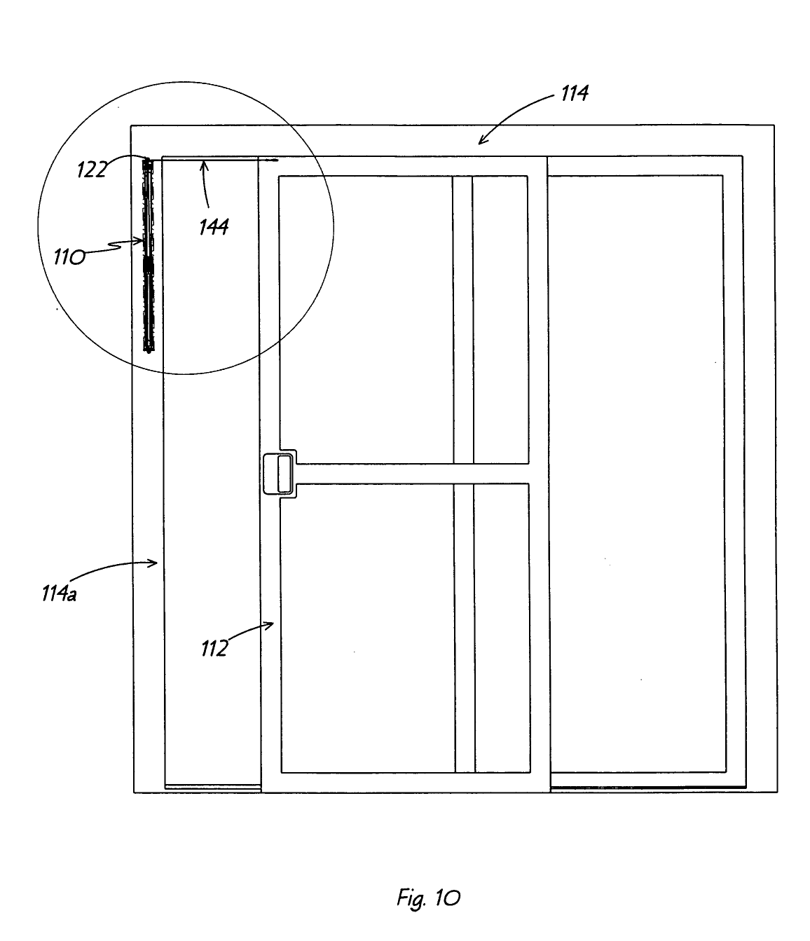

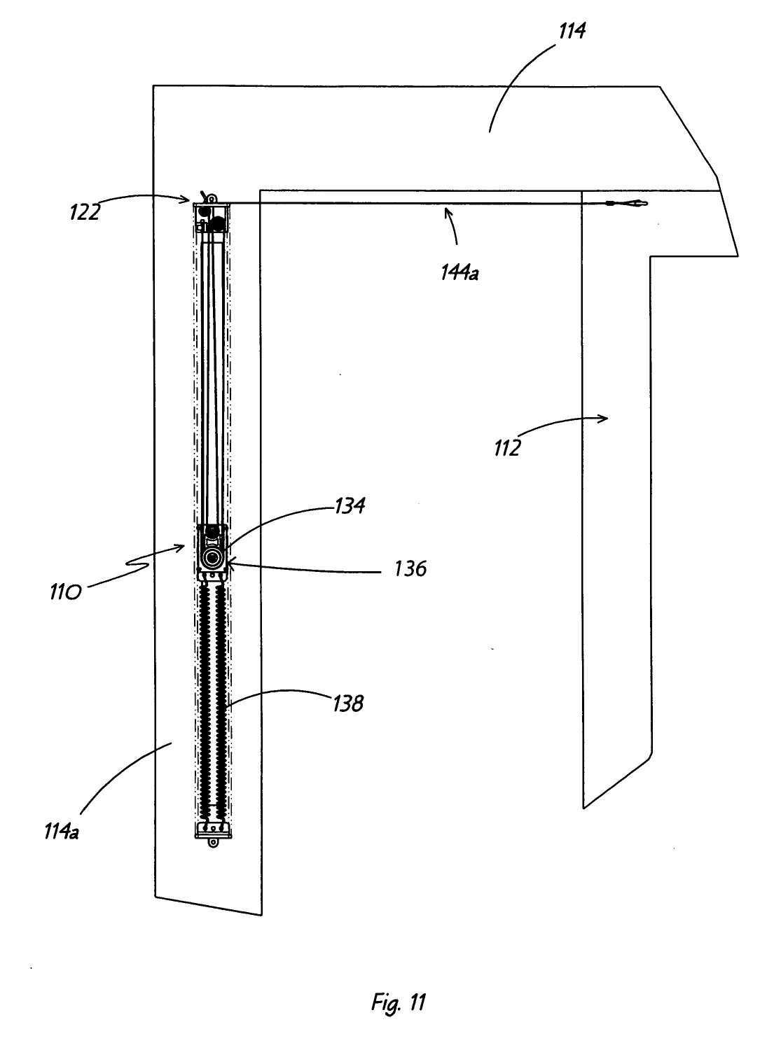

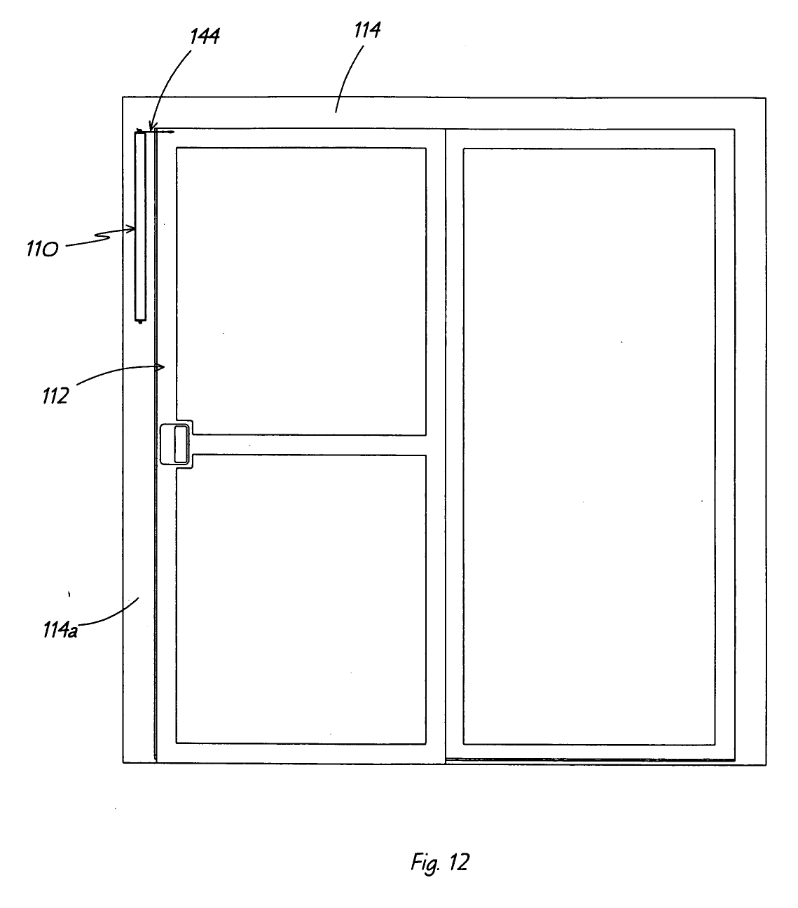

FIGS. 10-12 illustrate a second manner in which the automatic closer mechanism can be mounted. In this instance, the closer mechanism, generally indicated at 110 is mounted on the vertical upright 114a of door frame 114. Closer 110 is mounted so that the cable 144 extends horizontally out of end cap 122 and is connected at its free end to the top of door 112. As door 112 is moved from the closed position (FIG. 12) to the open position (FIG. 10) a length of cable 144a is drawn out of closer mechanism 110 and spring 138 is expanded in length. When door 112 is released, spring 138 reverts back to its original length thereby causing block 136 to slide along base 116 and drawing length 144a of cable 144 back through end cap 122, through the plurality of pulleys, including pulley 134, and thereby drawing door 112 back toward vertical upright 114a.

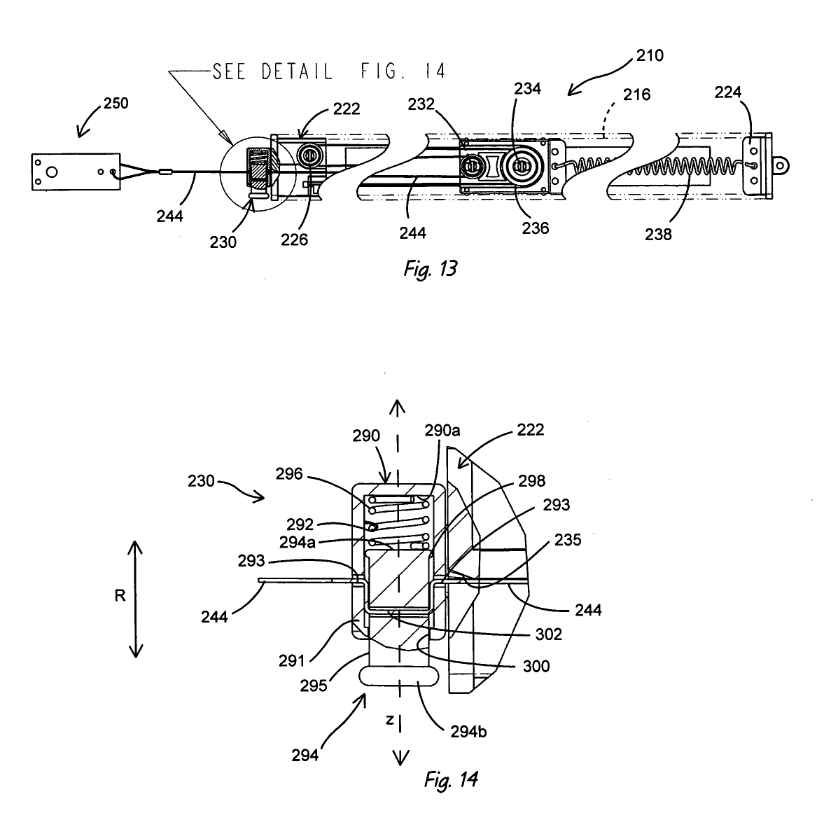

Referring to FIGS. 13-18, there is shown a second embodiment of the closer mechanism in accordance with the present invention and generally indicated at 210. Closer mechanism 210 includes the basic components found in closer mechanism 10, including end caps 222, 224 mounted on a base 216, a slidable block 236 and a plurality of pulleys 226, 232 and 234 around which a cable 244 is threaded. One or more springs 238 connect sliding block 236 and end cap 224.

In accordance with one of the specific features of the present invention, a second embodiment of the locking mechanism is provided and is generally indicated at 230. Locking mechanism 230 is a slide lock that comprises a cylindrical shaped housing 290 having a peripheral wall 291 that has an axial bore 292 therein. Housing 290 further includes a pair of aligned holes 293 in its peripheral wall 291. A generally cylindrical plunger 294 is received within bore 292 and a spring 296 is disposed between the upper end wall 294a of plunger 294 and the inner wall 290a of housing 290. Plunger 294 further has an exterior wall 295 that extends between upper end wall 294a and lower end wall 294b. Upper end wall 294a of plunger 294 includes an annular lip 298 that extends outwardly beyond the exterior wall 295. Lower end wall 294b of plunger 294 also extends outwardly beyond exterior wall 295. Housing 290 further includes an in-turned flange 300 at the entrance to bore 292. Flange 300 is sized so that neither the upper end wall 294a nor lower wall 294b can pass through the entrance to bore 292. Plunger 294 is able to slide in bore 292 between flange 300 and inner wall 290 as is indicated by the arrow “R” in FIG. 14.

Plunger 294 further includes a slot 302 that extends through exterior wall 291 substantially parallel to upper and lower end walls 294a, 294b and substantially at right angles to the longitudinal axis “Z” of housing 290. Cable 244 is threaded through holes 293 and slot 302. When plunger 294 is depressed inwardly into housing 290 and toward inner surface 290a, spring 296 becomes compressed between upper wall 294a and inner wall 290a. This movement also brings slot 302 into alignment with holes 293 in housing 290 and with aperture 235 in end cap 222. In this position, cable 244 can slide freely through locking mechanism 239 and locking mechanism 239 can therefore slide freely along cable 244 and can be moved closer to or further away from end cap 222.

When plunger 294 is released, spring 296 reverts to its original shape and position, thereby urging plunger 294 away from inner surface 290a of housing 290. This causes slot 302 to move out of alignment with holes 293 and, consequently, cable 244 cannot feed through holes 293 and slot 302 and locking mechanism 230 becomes locked into place on cable 244.

Locking mechanism 230 is designed to be slid along cable 244 and to be positioned at some location between fastener 246 and end cap 222. Locking mechanism 230 is therefore used in the following manner. If the homeowner wishes to have the door 212 automatically slide closed from a completely open position to a completely closed position, where door 212 abuts side frame 214a, then locking mechanism 230 is slid along cable 244 until it is positioned proximate fastener 246. If the homeowner wishes to keep the door 212 in a partially open position (such as is illustrated in FIG. 1), then locking mechanism 230 is slid along cable 244 until it is positioned a spaced distance away from side frame 214a. If door 212 is slid to the fully open position and then released, the closer mechanism 210 will automatically slide door 212 closed until end cap 222 encounters locking mechanism 230 on cable 244. Door 212 will stop at that position. Door 212 can be opened wider, but cannot be closed completely unless locking mechanism is slid back toward fastener 246. If the homeowner wishes to have the door 212 remain fully opened, then door 212 is opened to that extent and locking mechanism 230 is slid along cable 244 until it abuts end cap 222. This substantially prevents any closing movement of door 212 until locking mechanism 230 is slid along cable 244 toward fastener 246.

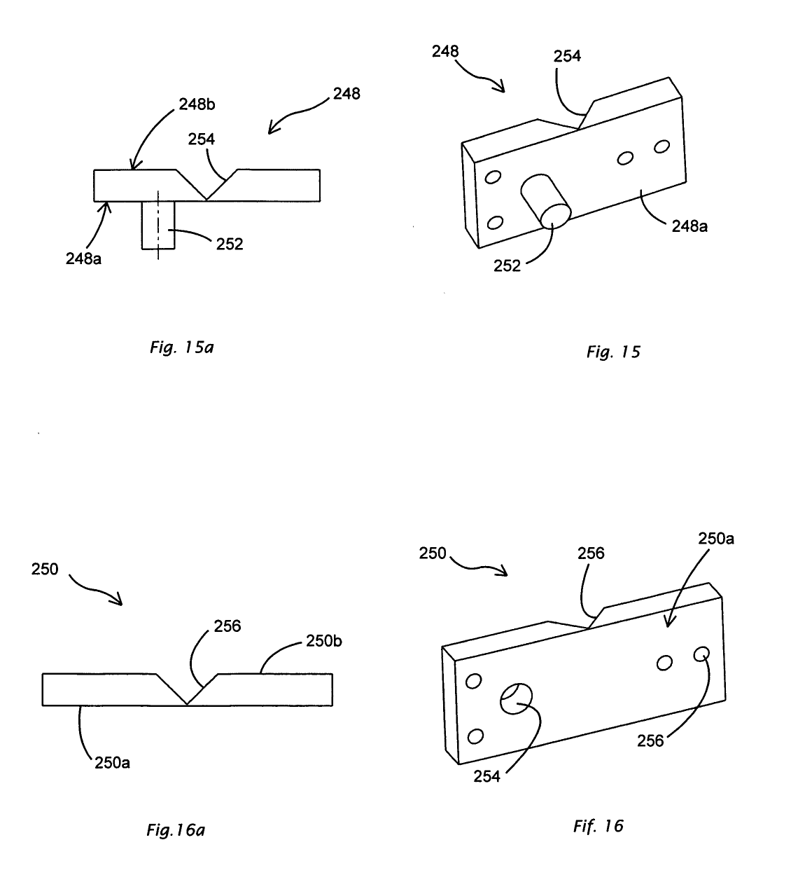

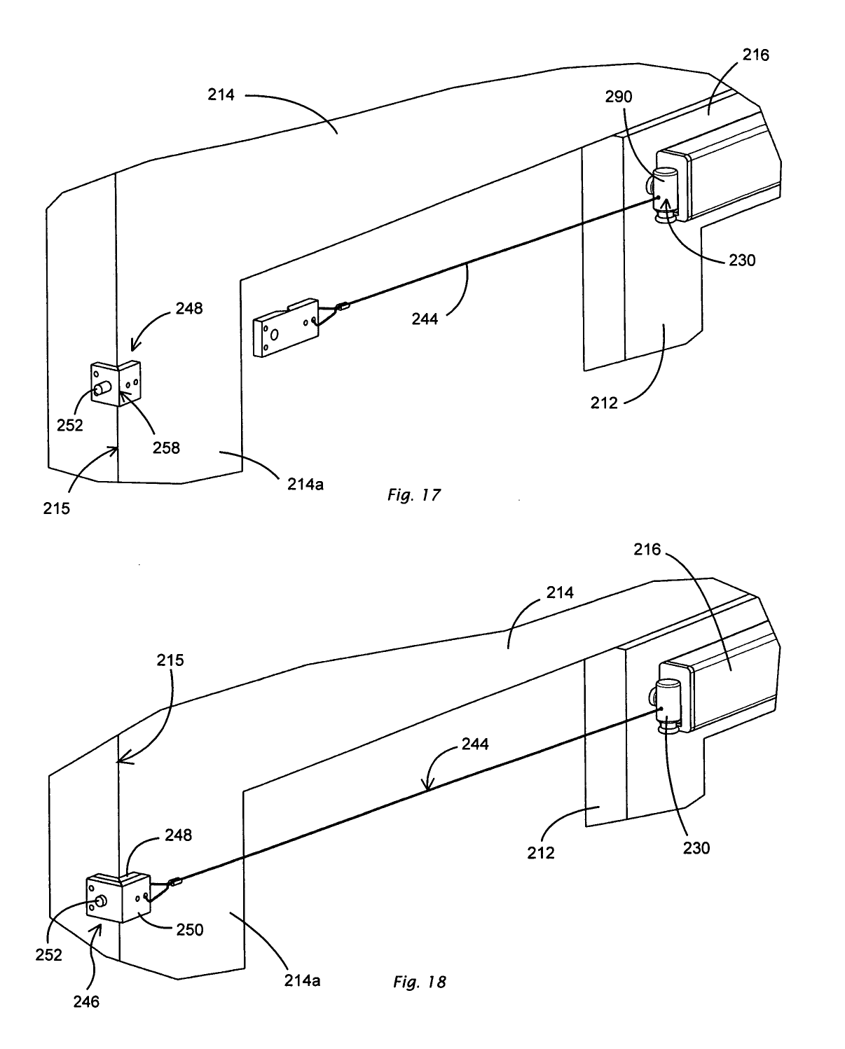

FIGS. 15-18 illustrate another embodiment of a fastener 246 that is designed to be applied to a corner 215 (FIG. 17) of a door frame 214. Fastener 246 comprises a plate 248 and a cover 250 that engage each other. Plate 248 is designed to be positioned on a corner 215 of door frame 214. Cable 244 is attached to cover 250 which, in turn, is engaged with plate 248. Plate 248 has a front surface 248a and rear surface 248b. Front surface 248a has a post 252 extending outwardly away therefrom. Rear surface 248b includes a V-shaped notch 254 that is shaped to receive corner 215 of frame 214 therein. An adhesive preferably is applied to rear surface 248b to secure plate 248 to frame 214. Alternatively, screws (not shown) may be used to secure plate 248 to frame 214.

Similarly, cover 250 has a front surface 250a and a rear surface 250b. Rear surface 250b includes a V-shaped notch 256 that is shaped to receive the corner 258 (FIG. 17) of plate 248 therein. Cover 250 further includes an aperture 254 that is positioned and sized to receive post 252 therethrough. Cover 250 further includes a second aperture 256 through which cable 244 is received and secured. An adhesive may be applied to rear surface 250b of cover 250 to allow plate 248 and cover 250 to be secured together. Alternatively, screws (not shown) may be used to secure the two components together.

It will be understood by those of ordinary skill in the art that base 16 may be formed as a two-part component instead of being formed as a substantially rectangular elongated member. In this former instance base will have a first part thereof mounted onto door 12 by tape 18 and a second part thereof being a snap-fitted cover that is received over the end caps, block and springs and which clips onto the first part of the base.

It will further be understood that while the present invention has been described in relation to horizontally sliding glass doors and sliding screen doors, it could easily be applied to horizontally or vertically closing windows as well.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention are an example and the invention is not limited to the exact details shown or described.

1. An automatic closer for a sliding door that is mounted in a door frame; wherein the automatic closer comprises:
a base securable to one of the sliding door and the frame;
a spring-biased block and tackle mechanism mounted on said base and including a cable which is securable to the other of the sliding door and the frame; and wherein a length of cable is drawn through the block and out of the base as the door is slid open and the length of cable is drawn through the block and into the base as the door is slid closed; and
a locking mechanism mounted on the base; the locking mechanism being selectively engageable with the cable to prevent the cable from moving either into or out of the base.

2. The automatic closer as defined in claim 1, further comprising:
a first end cap mounted on the base, said first end cap including an aperture through which the cable is threaded;
a second end cap mounted on the base a spaced distance from the first end cap; and wherein the block is disposed intermediate the first and second end caps.

3. The automatic closer as defined in claim 2, wherein the locking mechanism is a rotatable cam lock that is rotated in a first direction to engage a section of the cable and prevent the cable from moving through the block; and the cam lock is rotated in a second and opposite direction to disengage from the section of cable and allow the cable to move through the block.

4. The automatic closer as defined in claim 3, wherein a first part of the cam lock is mounted on the first end cap; and a second part of the cam lock extends outwardly through the aperture therein and is adapted to be engaged by hand to rotate the cam lock.

5. The automatic closer as defined in claim 4, wherein the cam lock includes a cam that is rotatable into a recessed area within the first end cap; and when the cam is so received into the recessed area the cable is wedged between the cam and an interior surface of the recessed area thereby substantially preventing further movement of the cable.

6. The automatic closer as defined in claim 1, wherein the locking mechanism comprises a slide lock; said slide lock comprising:
a housing having a peripheral wall with a pair aligned holes formed opposite each other, said housing further defining an axial bore therein;
a plunger complementary shaped and sized to be slidably received within the bore of the housing; said plunger including an exterior wall and upper and lower end walls;
a slot extending through the exterior wall of the plunger and disposed substantially parallel to the upper and lower end walls; said slot being aligned with the holes in the peripheral when the plunger is in a first position, and being out of alignment with the holes when the plunger is in a second position; and
a spring disposed between the upper end wall of the plunger and an interior wall of the housing.

7. The automatic closer as defined in claim 6, wherein the cable is threaded through the holes and slot of the housing and plunger and is slidable therethrough when the plunger is in the first position; and the cable is prevented from sliding through the holes and the slot when the plunger is in the second position.

8. The automatic closer as defined in claim 7, wherein the upper end wall of the plunger includes an annular flange and a bottom end wall of the housing includes an inwardly extending lip; and wherein the flange is engageable with the lip to substantially prevent the plunger from sliding completely out of the bore of the housing.

9. The automatic closer as defined in claim 1, further comprising a fastener that is connected to an end of the cable; and wherein the base is mounted to one of the sliding door and the door frame and the fastener is mounted to the other of the sliding door and door frame.

10. The automatic closer as defined in claim 9, wherein the fastener comprises an interlocking plate and cover, said plate being adapted to be secured to one of the sliding door and door frame and said cover being secured to the end of the cable.

11. The automatic closer as defined in claim 10, wherein the plate has a front surface and a rear surface and the rear surface includes a V-shaped notch that is adapted to receive a corner of the one of the sliding door and door frame therein, whereby the plate is adapted to engage two side walls of the one of the sliding door and door frame that form the corner.

12. The automatic closer as defined in claim 11, wherein the cover includes a front surface and a rear surface and has an aperture extending between the front and rear surfaces thereof; and wherein the front surface of the plate includes a projection that is complementary sized and positioned to be received through the aperture in the cover.

13. The automatic closer as defined in claim 12, wherein the rear surface of the cover further includes a V-shaped notch that is adapted to receive a corner formed by the plate when the plate is mounted on the corner of the one of the sliding door and door frame.

14. An automatic closer for a sliding door which is mounted for horizontal sliding motion within a door frame; the automatic closer comprising:
a base securable to one of the sliding door and the door frame;
a block;
a plurality of pulleys mounted on the block and on the base;
a cable secured at a first end to one of the block and the base and at a second end to the other of the sliding door and the door frame; said cable being threaded through the plurality of pulleys; whereby opening the door causes the cable to be drawn through the pulleys in a first direction and closing the door causes the cable to be drawn through the pulleys in a second direction; and wherein the movement of the cable causes the block to slide along the base;
a spring connected to the base at a first end and to the block at a second end; whereby said spring biases the door into a closed position;
a locking mechanism mounted on the base and being selectively engageable with the cable to prevent the cable from being drawn through the pulleys in either of the first and second directions.

15. The automatic closer as defined in claim 14, wherein the base defines an interior bore and the closer further includes a first end cap mounted to a first end of the base and a second end cap mounted to a second end of the base; and wherein the block is slidably movable within the bore of the base between the first and second end caps.

16. The automatic closer as defined in claim 15, wherein one of the first and second end caps defines an aperture therein, and a first part of the locking mechanism is mounted on that one of the first and second end caps which includes the aperture therein; and a second part of the locking mechanism protrudes outwardly through said aperture.

17. The automatic closer as defined in claim 16, wherein the locking mechanism further includes a cam which is rotatable between a first position where the cable moves freely through the aperture as the door opens and closes; and a second position where the cable is wedged between the cam and an interior surface of that one of the first and second end caps which defines the aperture.

18. The automatic closer as defined in claim 14, wherein the locking mechanism comprises a slide lock that is slidably mounted on the cable; and wherein said slide lock comprises:
a housing having a peripheral wall with a pair aligned holes formed opposite each other, said housing further defining an axial bore therein;
a plunger complementary shaped and sized to be slidably received within the bore of the housing; said plunger including an exterior wall and upper and lower end walls;
a slot extending through the exterior wall of the plunger and disposed substantially parallel to the upper and lower end walls; said slot being alignable with the holes in the peripheral when the plunger is depressed inwardly into the housing, and being out of alignment with the holes when the plunger is released; and
a spring disposed between the upper end wall of the plunger and an interior wall of the housing.

19. The automatic closer as defined in claim 18, wherein the cable is threaded through the holes and slot of the housing and plunger; and when the plunger is depressed inwardly the cable is able to slide through the holes and the slot; and when the plunger is released the cable is prevented from sliding through the holes and the slot.

20. The automatic closer as defined in claim 14, further comprising a fastener that is connected to an end of the cable; and wherein the base is mounted to one of the sliding door and the door frame and the fastener is mounted to the other of the sliding door and door frame; and wherein the fastener comprises an interlocking plate and cover, said plate being adapted to be secured to one of the sliding door and door frame and said cover being secured to the end of the cable.
